(19) United States
(12) Patent Application Publication
(10) Pub. No.: US 2013/0213108 A1
(43) Pub. Date: Aug. 22, 2013

(54) METHOD OF MAKING A STAMPED PART

(71) Applicant: Richard Paul KNERR, (US)

(72) Inventor: Richard Paul KNERR, (US)

(21) Appl. No.: 13/400,373

(22) Filed: Feb. 20, 2012

(51) Int. Cl. B21D 22/06; B23P 17/00

(52) U.S. Cl. 72/322

(57) ABSTRACT

A stamped workpiece for use as a motor-vehicle part is made by first forming from sheet metal an intermediate workpiece extending along an axis and forming in axially opposite ends of the workpiece respective outwardly directed V-shaped formations. The workpiece is then set directly or indirectly via blank holders on one die of a stamping apparatus and one of the formations is engaged with a complementarily shaped element of the one die. Then another element complementary to the other of the formations is engaged against the other formation and the workpiece is axially gripped between the elements. Finally, another die of the apparatus is pressed against the workpiece on the one die to stamp the workpiece into a finished shape.

### FIELD OF THE INVENTION

The present invention relates to method of making a stamped part. More particularly this invention concerns the production of shaped sheet-metal vehicular parts.

### BACKGROUND OF THE INVENTION

In the mass-production manufacture of parts from it is standard to cut from a strip of sheet metal a starting workpiece having a flat shape with an outer edge generally conforming to the final shape the part is to have. This starting workpiece is typically of the desired thickness, whether that is a uniform or varying thickness, of the finished part. It can be made of aluminum or magnesium alloys or HSS steel, and can be coated with zinc and/or an aluminum-based alloy to prevent scaling and decarbonization during heat treatment and to protect the finished part against corrosion.

The starting part is normally subject to one or two intermediate treatments, namely tempering of all or part of the part when it is made of press-hardenable steel, in particular 22MnB5 and possibly formation in it of so-called datum holes that are accurately dimensioned and oriented to fit with the grabs of manufacturing robots during later installation of the part and shaping of the sheet-metal part between dies of a press. This shaping in a press can be accompanied by or followed by trimming of the edges of the piece so its outer edge corresponds exactly to a desired shape.

After such intermediate treatments the workpiece, typically as a result of the intermediate treatments, does not have the exact final shape desired and is subjected to a final hot or cold stamping the trims off edges and/or otherwise imparts to the workpiece the desired final shape.

Numerous elements such as seat, bumper, and door beams, columns, and suspension parts are made in this manner in very large quantities. Thus they must be manufactured at the lowest possible cost, while at the same time complying exactly to the desired shape, dimensions, and orientation of the datum holes and formations. Any deviation will make the part unsuitable for mass-production manufacturing with assembly robots.

Since the final shape is imparted in the final hot or cold stamping operation after the datum holes have been formed in the workpiece, it is standard to use these datum holes to position the workpiece between the dies of the stamping apparatus. Thus the workpiece must be gripped and set on pins or the like in one of the die parts, which pins are oriented to fit in the datum holes.

The problem with this is that the outer edge of the workpiece is not to exact specifications, while the datum holes, which are to exact specifications, need to be left free so that the alignment pins in the stamping die can be fitted with them. The result is that the workpiece can be mispositioned in the stamping die, resulting at best in a spoiled piece and at worse in a damaged die or production-line shutdown. Furthermore when not perfectly positioned, stress peaks at edge recesses can result in micro cracks making the finished product unusable.

It has therefore been proposed to cut C- or U-shaped bumps or recesses in at least one long side of a starting workpiece that can be fitted with a complementary side formation in the lower stamping die. Another such formation or a transverse pusher on the die presses the C- or U-shaped formation against the complementary formation of the die to accurately position the workpiece in the die. This process also results in scrap increase when positioning in a later cutting region of the sheet metal.

This is also not highly effective as the various intermediate treatments can change the outer contours of the part so that these edge formations will not be accurately oriented relative to the datum holes and the finished workpiece will be off spec and unusable. A minor deviation between C- or U-shaped bumps or recesses and the complementary side formation in the lower die results in a much larger deviation at the longitudinal axis of the workpiece.

### OBJECTS OF THE INVENTION

It is therefore an object of the present invention to provide an improved method of making a stamped part.

Another object is the provision of such an improved method of making a stamped part that overcomes the above-given disadvantages, in particular that allows high-speed mass-production stamping.

### SUMMARY OF THE INVENTION

A stamped workpiece for use as a motor-vehicle part is made by first forming from sheet metal an intermediate workpiece extending along an axis and forming in axially opposite ends of the workpiece respective outwardly directed V-shaped formations. The workpiece is then set directly or indirectly via blank holders on one die of a stamping apparatus and one of the formations is engaged with a complementarily shaped element of the one die. Then another element complementary to the other of the formations is engaged against the other formation and the workpiece is axially gripped between the elements. Finally, another die of the apparatus is pressed against the workpiece on the one die to stamp the workpiece into a finished shape.

In this manner the workpiece is exactly positioned between the two elements and can be stamped with a high degree of accuracy.

According to the invention at least one of the formations is an outwardly open notch and the respective element is a wedge fittable in the notch. Alternately, at least one of the formations is an outwardly pointing tooth.

The sheet metal according to the invention is steel that is heated at least partly to an austenitic AC₃ temperature before being shaped in the stamping apparatus. In addition one of the dies is cooled to press-quench the workpiece while stamping it. To allow axial shrining of the workpiece during quenching part of one of the dies is allowed to move during stamping.

Furthermore according to the invention a plurality of datum holes is formed in the workpiece prior to stamping.

### BRIEF DESCRIPTION OF THE DRAWING

The above and other objects, features, and advantages will become more readily apparent from the following description, reference being made to the accompanying drawing in which:

FIG. 1 is a small-scale schematic view of a process according to the invention;

FIGS. 2 and 3 are perspective small-scale views of a press according to the invention when empty and when loaded;

FIG. 4 is a larger-scale perspective view of a detail of the loaded press and the device for loading a blank or intermediate workpiece into the press;

FIG. 5 is a top view of the structure of FIG. 4 illustrating this invention; and

FIGS. 6, 7, and 8 are detail views of end formations according to the invention.

### DETAILED DESCRIPTION

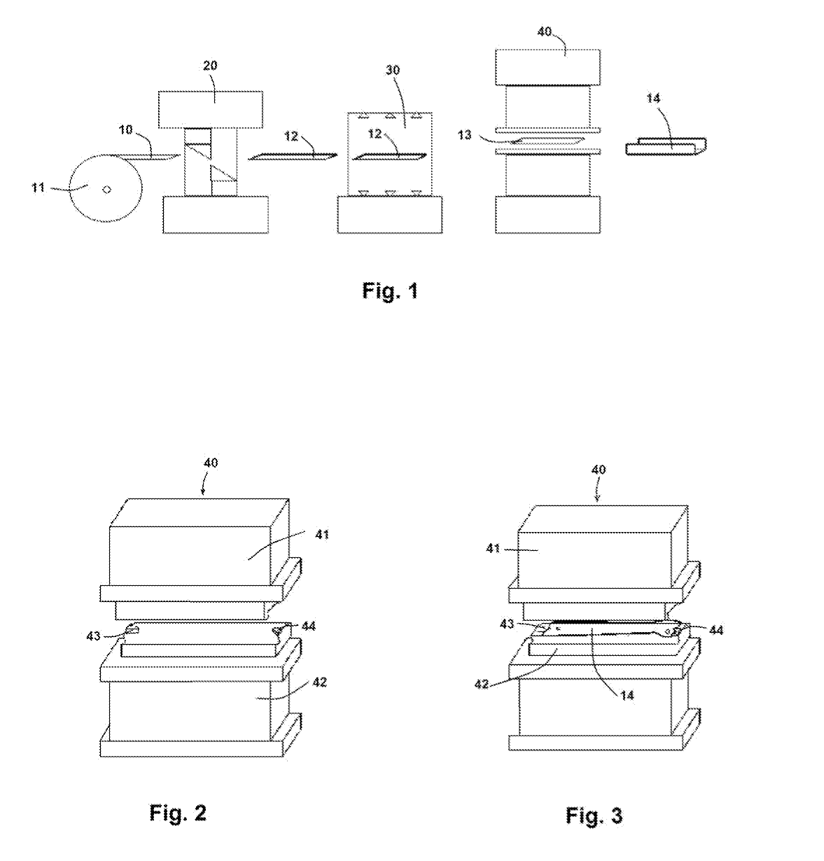

As seen in FIG. 1 a strip workpiece 10 is pulled from a coil 11 and passed through a cutting machine 20 that cuts discrete elongated first-stage intermediate workpieces 12 from the strip 10 and delivers them to an intermediate processing machine 30. There the workpieces 12 can be tempered by being to start with heated to a predetermined temperature, namely a temperature that allows austenitizing the grain structure of the metal.

It also possible to drill or otherwise form so-called datum holes 15, 16, 17 (FIG. 5) that are spaced parallel and transverse to a longitudinal axis L of the workpiece 12. The first-stage intermediate workpieces 12 are thus transformed into second-stage intermediate workpieces 13 that are moved downstream in a transport direction D by an unillustrated conveyor to a press 40 where they are hot- or cold-stamped into finished workpieces 14.

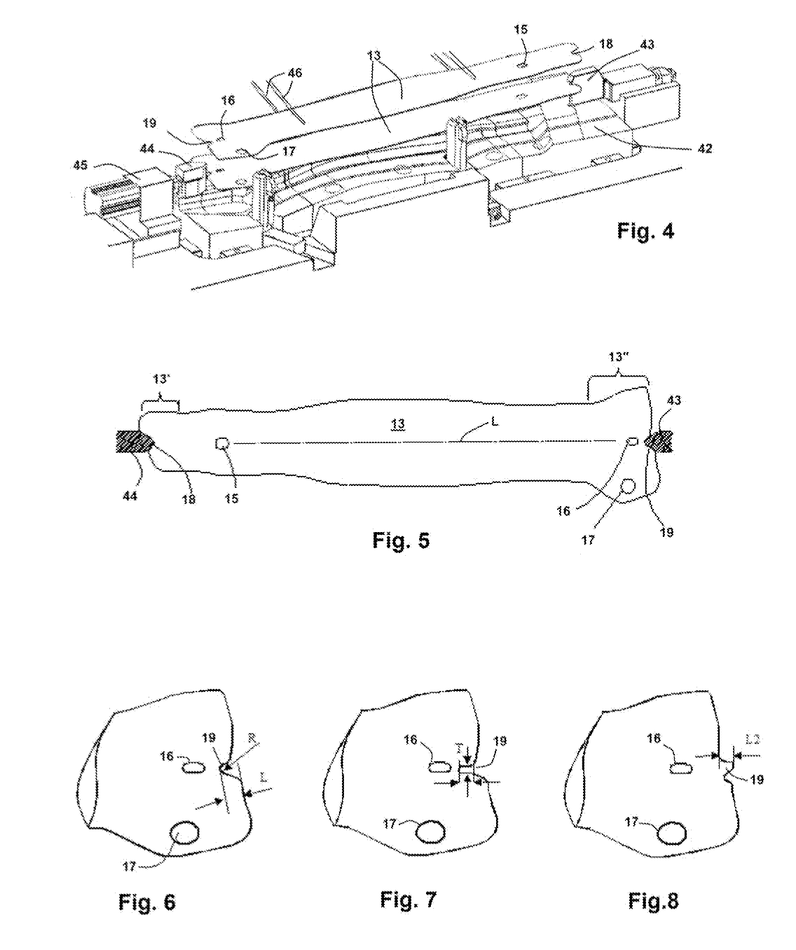

According to the invention the cutting machine 20 that cuts discrete workpieces 12 from the strip also cuts as shown in FIG. 5 a longitudinally outwardly directed V-shaped formation 18 and 19 into each longitudinal end of the workpiece 13. These formations are shown in FIGS. 4 and 5 as simple V-shaped recesses with flat flanks and of a longitudinal depth equal to between 5 mm and 50 mm and a maximum width of between 5 mm and 25 mm. Thus there are no deviations possible between the edges and the formations 18 and 19. Parts of the stamping machine may be cooled for use with hot sheet metal of press-hardenable steel.

It is also possible as shown in FIG. 6 for the formation 19 to be a V-shaped recess with a base radius R of 10 mm and a depth L of 25 mm. FIG. 7 shows a recess 19 with an inner region having parallel side walls extending parallel to the centerline L and spaced at a distance T and a flaring outer region. FIG. 8 shows a V-shaped formation 19 that is actually an outwardly directed V-shaped tooth.

The stamping machine 4 as shown in FIGS. 2, 3, and 4 has an upper die or part 41 that can move vertically and a fixed lower die or part 2. The lower part is provided with positioning formations 43 and 44 formed as wedges pointing toward each other. The wedge 44 is mounted on an actuator 45 so it can be displaced toward and away from the other wedge 43. In use the wedge 44 is retracted by the actuator 45 and a robot grab 46 sets the workpiece 13 in place, fitting its formation 19 with the fixed alignment wedge 43, then laying the workpiece 13 down on the lower die 42, and finally advancing the other wedge 44 longitudinally inward to engage in the other formation 18 and solidly and accurately position it in the lower die 42. It is also possible to lay the workpiece 13 down onto blank holders instead of or in addition to the lower die 2 in case of a more complexly shaped workpiece with a center of mass offset from its geometric center.

The wedges 43 and 44 can be spring loaded so they can be pushed down into the lower die 42 as the press 40 closes.

Thus with the instant invention the formations 18 and 19 are perfectly oriented with respect to the datum holes 15-17 so that when the workpiece is finish stamped, usually with trimming and aligning of its edges, the datum holes 15-17 are perfectly positioned.

I claim:

1. A method of making a stamped workpiece for use as a motor-vehicle part, the method comprising the steps of sequentially:
forming from sheet metal an intermediate workpiece extending along an axis;
forming in axially opposite ends of the workpiece respective outwardly directed V-shaped formations;
setting the workpiece directly or indirectly on one die of a stamping apparatus and engaging one of the formations with a complementarily shaped element of the one die;
engaging another element complementary to the other of the formations against the other formation and gripping the workpiece axially between the elements; and
pressing another die of the apparatus against workpiece on the one die and thereby stamping the workpiece into a finished shape.

2. The method defined in claim 1, wherein at least one of the formations is an outwardly open notch and the respective element is a wedge fittable in the notch.

3. The method defined in claim 1, wherein at least one of the formations is an outwardly pointing tooth.

4. The method defined in claim 1, wherein the sheet metal is steel.

5. The method defined in claim 1, further comprising the step of:
heating the sheet metal at least partly to an austenitic AC₃ temperature before shaping the sheet metal in the stamping apparatus.

6. The method defined in claim 1, further comprising the step of:
cooling one of the dies to press-quench the workpiece while stamping it.

7. The method defined in claim 6, further comprising the step of:
moving part of one of the dies during stamping to follow axial shrinking of the workpiece during quenching.

8. The method defined in claim 1, further comprising the step of:
forming a plurality of datum holes in the workpiece prior to stamping.
